(19) United States
(12) Patent Application Publication
(10) Pub. No.: US 2008/0059308 A1
(43) Pub. Date: Mar. 6, 2008

(54) METHODS AND APPARATUS FOR USING POLL RESULTS TO TARGET AND/OR SELECT ADVERTISEMENTS

(76) Inventor: DAVID GERKEN, MARINA DEL REY, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/849,219

(22) Filed: Aug. 31, 2007

Related U.S. Application Data
(60) Provisional application No. 60/842,292, filed on Sep. 2, 2006.
(60) Provisional application No. 60/927,257, filed on May 2, 2007.

(51) Int. Cl. G06Q 30/00

(52) U.S. Cl. 705/14

(57) ABSTRACT

Methods and apparatus for using information relating to answers to polling questions to select an advertisement and/or a link to an advertisement to be provided to a corresponding user or computer system are described. The selection process may use information obtained from soliciting, tracking, aggregating and/or reporting popular and group-specific opinion via the Internet.

### RELATED APPLICATIONS

The present application claims the benefit of U.S. Provisional Patent Application Ser. No. 60/842,292, filed Sep. 2, 2006, titled “METHODS AND APPARATUS FOR SOLICITING, TRACKING, AGGREGATING AND/OR REPORTING OPINIONS” and the benefit of U.S. Provisional Patent Application Ser. No. 60/927,257, filed May 2, 2007, titled “METHODS AND APPARATUS FOR SOLICITING, TRACKING, AGGREGATING AND REPORTING POPULAR AND GROUP OPINION VIA THE INTERNET”, both of which are hereby expressly incorporated by reference.

### FIELD OF THE INVENTION

The present invention relates to methods and apparatus for soliciting, tracking, aggregating and/or reporting opinions, e.g., via the Internet.

### BACKGROUND

The Internet has long been utilized to solicit user opinions on a wide range of issues. User polls are frequently incorporated into consumer Web properties such as news sites, Web portals and various other entertainment and information sites, with poll results updated and posted continuously or periodically on those sites. Such polls provide not only an immediate measure of popular opinion on current issues, but also a stimulus for further user engagement such as through related online discussions or related search queries.

More recently, online social networks and user-generated content sites have quickly emerged to become dominant forces in online media. Consumers have demonstrated a clear interest in greater opportunity for participation and personal expression on the Web.

In this environment, there is a need for an Internet service and related methods and apparatus for soliciting, tracking, aggregating and reporting popular and group opinions and predictions on a wide range of individual issues and topics. It would be desirable if methods and apparatus could be developed which encompass editor-generated and/or user-generated polls, and/or facilitate distribution of individual poll modules across the Internet, e.g., to third-party Web sites, personal Web pages and/or via email. It should be appreciated that there is also a need for improved methods and apparatus to aggregate and/or present a plurality of poll modules, such as on the Web site of a poll module aggregator.

### SUMMARY OF THE INVENTION

Various embodiments of the invention relate to methods and apparatus for soliciting, tracking, aggregating and/or reporting popular and/or group-specific opinions.

Some embodiments are directed to using information relating to answers to polling questions to select an advertisement and/or a link to an advertisement to be provided to the corresponding one of said user and said computer system.

Opinions and other poll results collected in accordance with the invention may be on one or more individual issues. The methods of the invention are well suited for use with the Internet. Various features are directed to the creation of individual poll modules, referred to herein as graphical polling modules, or GPMs, by editors and/or Internet users; the dissemination of these individual polling modules across the Internet via third-party Web sites, personal Web pages and emails; and/or the aggregation and presentation of a plurality of Graphical Polling Modules (GPMs), such as on the Web site of a poll module aggregator.

In various embodiments of the invention, a service is created for soliciting and tracking popular opinion and predictions on a wide range of individual topics and issues. GPMs serve as the basis upon which some of the service models of the invention are implemented. These easily digestible opinion snapshots can form the building blocks of a poll aggregation Web site. They can also be easily posted to third-party Web sites, personal Web pages and emails, promoting distribution that can help to expand voter participation while generating broad exposure for the service brand. Such a distribution approach may be implemented using a viral distribution approach where pre-exiting social networks are used to produce increases in brand awareness and/or distribution of polling modules, e.g., through self-replicating processes. While the term viral is used here, it is not to be confused with the term “computer virus” and it should be appreciated that the applicant is, in no way suggesting or promoting the use of computer viruses.

GPMs can be created by service staff and/or Internet users, capitalizing on consumers' demonstrated demand for greater participation and self-expression on the Web. GPMs can be actively managed on a poll aggregation Web site to provide a fresh, timely, concise view of popular opinion on both mainstream and/or offbeat issues. They can, in some embodiments, also be made accessible in a more open, unrestricted format in areas of the poll aggregation site. In addition, GPMs can be created and distributed for personal use, such as to solicit opinions from friends (e.g., “Should we have the party on Friday or Saturday night?”).

Advertisements may be selected based on a users poll answers. The selection may be made based on information about the user's own answer history as compared to the answer history of other users who found particular advertisements of interest, e.g., as indicated by the user clicking on the advertisement. For purposes of selecting advertisements, poll and advertising information may be stored for groups of users where the groups may be determined based on answers to poll questions and/or physical characteristics such as age, sex, weight, etc and/or social characteristics such as community groups to which the user belongs, interests expressed by the users, etc. Thus advertisements may be selected based on the past polling behavior of an individual user as well as other features or information that can be used to match the user to others such as, for example, the past polling behavior of other users, social and/or other similarities between the individual user and other users. Once a user is matched to another user or group of users for add selection purposes, information indicating interest of the other users in past advertisements and/or products can be used to select an advertisement and/or advertising link for presentation to the individual user.

In some embodiments when a computer system is shared by multiple users, advertisement selection may be performed on a per computer system basis as opposed to a user basis.

Selected advertisements and/or links need not be presented immediately but may be presented, e.g., after a user has left a polling web site and is visiting another web site.

In some embodiments revenues are generated through a paid search partnership and contextual advertising within pages on the poll aggregation Web site, as well as through advertising or sponsorships embedded directly in GPMs.

In some such embodiments, revenue information is generated and stored. Reports are generated indicating revenue received and/or indicating the party to which revenue is to be attributed. Revenue reports are generated and in some cases printed. Actual monetary payments may, and sometimes are, made by the system in accordance with the revenue tracking and accounting procedures.

Functional Overview

The service model in some embodiments of the invention is based on the use of one or more GPMs. In some embodiments individual GPMs are implemented as discrete, graphical polling modules that can form the basic building block for a variety of polling services. GPMs can be utilized across multiple environments including a poll aggregation Web site, where GPMs can be organized and managed by category and can also be made searchable by keyword, and across the Internet, where users and publishers can post individual GPMs (both those discovered on the poll aggregation Web site or created independently using a tool available on the site or elsewhere) to publisher Web sites, personal Web pages or emails.

Select functions of the service system, in some embodiments of the invention, include:

user registration—While, in some embodiments, anyone can view the poll aggregation site or individually posted GPMs, contributing to GPM content may require that users be registered with the site.

GPM creation—Enabling both service staff and users to create individual GPMs for posting to the site (e.g., after optional review and approval by service staff) and elsewhere.

GPM rendering—Processing the data in GPM records and rendering the results in, e.g., a consistent, easily digestible graphical format across various delivery modes.

GPM interaction management—Enabling user interaction with GPMs, including voting on, posting or sharing the GPMs as well as viewing or adding voter comments.

GPM aggregation site navigation—Providing an overall navigation framework (i.e. site design) for users of the poll aggregation site based on the GPM directory structure.

GPM aggregation/management—Enabling authorized service staff to easily select and arrange GPMs to create pages of a poll aggregation site.

GPM search—Enabling keyword search of the GPM database, with results ordered based on multiple selectable parameters.

Web search—Incorporating traditional Web search functionality, including presentation of sponsored search results.

ad product integration—Supporting consistent integration of text and/or display advertisements on some poll aggregation site pages.

reporting—Providing the ability to generate standard reports summarizing various statistics related to the site, GPMs and users.

Select Functional Specifications Applicable to Some But Not Necessarily All Embodiments

Expanding on this functional overview, the following is a more detailed description of select functions of some embodiments of the invention.

### GPM Creation

Service staff and users can utilize the same GPM creation tool. The creation tool can be accessible to users via the service home page and at various other points across the site or elsewhere. Users may be required to register with the site before being permitted to create a GPM.

In creating a new GPM, the creator may be asked to specify the following:
question type, choosing from visual examples of corresponding GPMs—Initially, two GPM question templates may be available: 1) multiple choice (with a select number of possible answers) and 2) point spread (specifying a winner and point spread). The number of question types available to users may be increased or decreased over time, and certain types may be accessible only to service staff.
question
answer options—In the case of the point-spread question type, creators may be prompted to specify the sport (e.g., football, basketball, baseball, hockey) to enable the point units (e.g., points, runs, goals) to be automatically determined.
poll closing date
tally period—Providing an option to display tallied results for the full polling period or just the most recent xx days.
public/private setting—Providing an option for users to 1) use the GPM for their own use, 2) submit the GPM for possible posting to the poll aggregation site, or 3) both.
GPM category—Providing the ability to classify GPMs based on the current GPM directory structure (may not be required for private GPMs).

Throughout the creation process, users may have simple, one-click access to help on each current topic.

### GPM Rendering

GPMs may be rendered in a consistent, graphical, easily digestible format and continuously, periodically or otherwise updated on the user's display. GPMs may, and normally are, rendered consistently across various delivery modes, including on a poll aggregation site, third-party Web pages, personal Web pages, and in emails.

Each GPM may include one or more of the following:
question and the available answer options, with clickable voting buttons that are color-coordinated with the results graph
a results graph summarizing the current voting results, as well as subtle text indicating “[x,xxx] votes since [start date of current tally window]” and “[days remaining to vote] days remaining.” Poll results may be updated on the user's display in real-time (e.g., every few seconds) and immediately reflect changes resulting from the user's own vote
a subtle, clickable “voter comments” option
a subtle, clickable “post this GPM” option (except in the case of private GPMs)
a subtle “created by: [username of creator]” in the case of user-created GPMs

When presenting poll results, graph percentages may be calculated to the nearest whole number. Results may be represented as pie charts for questions with two answer options and as vertical bar charts for questions with 3-5 answer options. In the case of polls involving unconstrained number inputs, basic provisions may be included to filter out extremes. These could include presenting the median rather than the mean for smaller voting samples and/or filtering out results beyond some multiple of the standard deviation for larger samples.

Finally, when a user is logged in or otherwise recognized, each GPM may graphically indicate whether the user has already voted on each within the current tally window.

### GPM Interaction Management

Users may be able to interact with individual GPMs in a number of ways. These may include:
voting—When a user clicks on one of the answer buttons, if the user is registered with the service or otherwise tracked, the vote may be immediately registered if that user has not already voted on the GPM during the current tally window. The vote completion may be made apparent to the user, such as with a slight graphical change to the selected answer button and, if practical, an immediate update to the displayed results. If the user has already voted on the GPM during the current tally window, a message may appear indicating such. Finally, if the user is unregistered or otherwise currently untrackable, the user may be prompted to register or log in.
viewing and/or adding voter comments—When a user clicks on the “voter comments” icon, a new browser window may open showing the voter comments page for that GPM. Users can then submit comments via this page.
posting/sharing: When a user clicks on the GPM posting/sharing option, a small window may open facilitating the request to post the GPM to a Web page or to email to one or more friends.

### GPM Aggregation Site Navigation

In some embodiments of the invention, users of a poll aggregation service may peruse GPMs in multiple ways including by keyword search, or by navigating the site's directory-based structure. The home page may include a daily features section, highlighting a small number of editor-selected GPMs on a variety of timely topics, as well as one or more GPMs each from select top categories.

The home page of the poll aggregation site may also include a prominent option for users to create their own GPMs, encouraging user involvement in expanding site content while at the same time promoting a key distinguishing aspect of the service model. In addition, a search box may be prominently featured on site pages, enabling direct search-based access to the GPM database or the Web.

Subsequent poll aggregation site pages may include a directory navigation tool enabling single-click navigation among the various GPM topic categories. Each topic page may then feature top editor-selected GPMs in that category followed by a list of GPM poll questions in that category presented in a format similar to the GPM search results (see below), except with “relevance” replaced by “date created” as the default ordering criterion.

An exemplary GPM directory is included below. This directory structure may be easily modifiable to enable changes or expansion as user activity and events warrant.

### User Registration

Normally, users may view any portion of the poll aggregation site or individually posted GPMs without having to register. However, in some embodiments, registration with the service may be required to contribute to GPM content (e.g. adding comments to, creating, and/or voting on). When a user first attempts to execute any of the above actions, he may be prompted to login or, if not yet registered, register by providing an email address, username and password.

### GPM Search

One of the ways users may interact with the poll aggregation site is through keyword search of the GPM database. A GPM/Web search box may be prominently displayed on site pages. When a GPM search is executed, relevant GPMs may be organized and presented based on multiple parameters including, in some embodiments of the invention, “relevance,” “date created,” “time remaining,” and “votes cast.” Users may also be able to select between searching results from featured GPMs (i.e. those created or reviewed and incorporated by service staff) or all GPMs, including unreviewed user submissions, with the former as the default setting in one or more embodiments of the invention. Individual featured GPMs and those not created or reviewed by service staff may be presented in a way such as to be easily distinguishable.

### Web Search

The poll aggregation site may incorporate traditional Web search functionality, including presentation of sponsored search results. Results may be displayed per the specifications of a search partner, but within the service's own branded environment.

### Advertising Integration (Non-Search Related)

The poll aggregation site may include tasteful contextual text and display advertising presented in a consistent manner across category pages.

### GPM Aggregation/Management

Managers of a poll aggregation site may utilize a GPM aggregation/management system to assemble and organize GPM collections to create pages of the poll aggregation site. The tool may provide site managers centralized access to the GPM creation tool, GPM search tool (with particular emphasis on searching the most recently created GPMs), and an assembly tool allowing managers to organize collections of GPMs to create each page of the site.

### Reporting

Initially, reporting requirements may be focused on site traffic (e.g. unique users, page views, etc.) to facilitate basic traffic analysis. During the first months of operation, existing tools such as the GPM search tool and the ad tracking tools of the designated search partner may be utilized for other reporting purposes. Additional reporting requirements may be defined after site launch.

### GPM Directory Structure

In some embodiments of the invention, GPMs may be optionally categorized by service staff and/or users according to a GPM directory structure, such as the exemplary directory structure provided below.
Entertainment

movies

television

music

games

celebrities

fashion

other
Sports

football

basketball

baseball

hockey

soccer

other
News & Politics

domestic issues

world issues

politicians

other
Business & Finance

stocks

real estate

the economy

other
Other

technology

religion & philosophy

offbeat

miscellaneous/other

### Additional Functionality

Additional features of some embodiments of the poll aggregation site and related poll services include:
1) Wherever GPM questions are part of a list, rather than presented in full, enabling graphical pop-up of GPM output on mouse rollover;
2) Coordinating outbound email updates to GPM creators to provide periodic updates on viewing, voting and/or other activity related to the GPM(s) they created;
3) Coordinating periodic outbound emails with featured GPMs in specified categories to requesting users;
4) Providing the ability to view historical voting trends for GPMs open over long periods (e.g., consumer sentiment);
5) Providing the ability to request, receive and/or generate user profiles (e.g. age, gender, city/state, etc.) and enabling custom segmentation of individual poll results based on profile parameters;
6) Enabling additional question types (e.g. number inputs);
7) Providing for cross-platform GPM distribution/optimization (such as to/from mobile devices); and
8) Providing for scheduling and coordination of GPM creation and management to assist editors in creating, editing and/or managing recurring and/or time sensitive GPMs.

While various embodiments have been discussed in the summary above, it should be appreciated that not necessarily all embodiments include the same features and some of the features described above are not necessary but can be desirable in some embodiments. Accordingly, all the features discussed above should not be interpreted as being required in each embodiment of the invention. Numerous additional features, embodiments and benefits are discussed in the detailed description which follows.

### BRIEF DESCRIPTION OF THE DRAWINGS

FIG. 1 is a flowchart of an exemplary method of aggregating, disseminating and tracking graphical polling modules in accordance with the invention.

FIG. 2 illustrates two sample graphical polling module database records implemented in accordance with the present invention.

FIG. 3 illustrates a graphical polling module provisioning system implemented in accordance with the present invention.

FIGS. 4-15 illustrate various features of the invention which can be appreciated from the various display outputs, e.g., screen shots, shown in these figures.

FIG. 16 is a flowchart of an exemplary method of operating a computer system in accordance with various embodiments.

FIG. 17 is a flowchart of an exemplary method of targeting advertisements in accordance with various embodiments.

FIG. 18 is a drawing of an exemplary computer system in accordance with various embodiments.

FIG. 19 is a drawing of an exemplary system for targeting advertisements in accordance with various embodiments.

### DETAILED DESCRIPTION

The present invention relates to methods and apparatus for soliciting, tracking, aggregating and reporting popular and/or group-specific opinions, e.g., via the Internet.

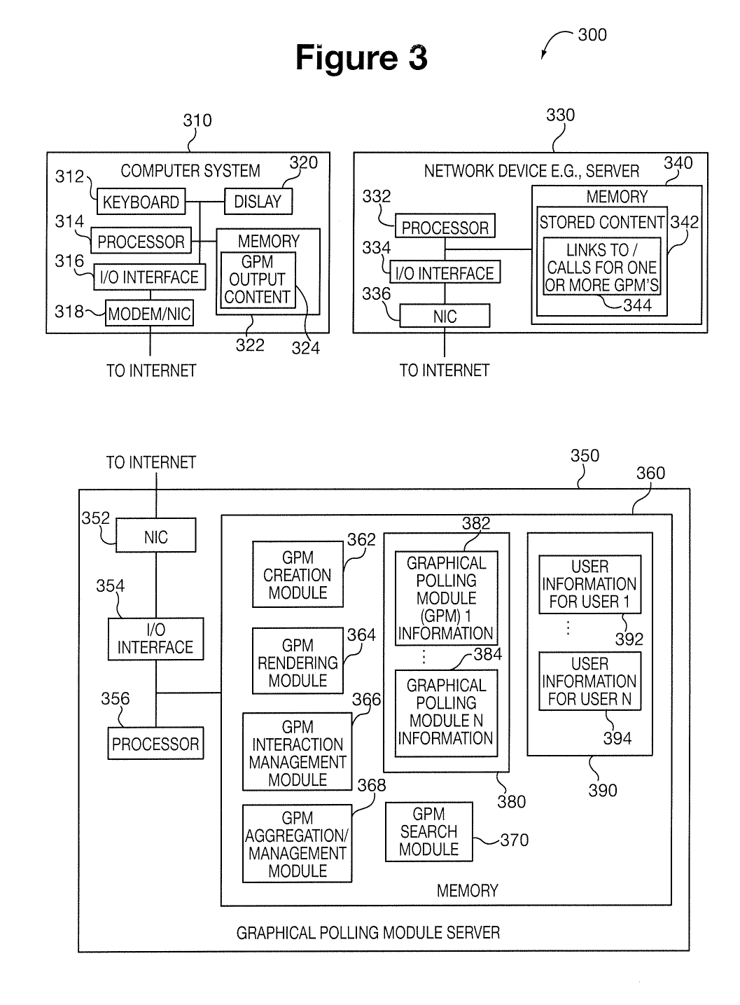

Before proceeding to discussing the methods of the present invention, an exemplary system implemented in accordance with one exemplary embodiment of the invention will first be described with regard to FIG. 3.

FIG. 3 illustrates an exemplary graphical polling module provisioning system 300 implemented in accordance with the present invention. System 300 includes: a graphical polling module server 350; a computer system 310, such as, for example, a PC; and a network device 330.

Graphical polling module server 350 includes NIC (Network Interface Card) 352, I/O interface 354, processor 356 and memory 360. The processor 356 controls operation of the GPM server 350 under control of one or more modules stored in memory 360. Memory 360 includes: a GPM creation module 362; GPM rendering module 364; GPM interaction management module 366; GPM aggregation/management module 368; GPM search module 370; a plurality of GPM information sets 382, 384 in a GPM database 380; and a plurality 390 of user information sets 392, 394 which are implemented in accordance with the invention. GPM creation module 362 controls the receiving and storing of GPM information in GPM database 380. GPM rendering module 364 controls the processing and presentation of GPM information to render GPM output, including, for example, poll questions and answers and graphical summaries of poll results. GPM interaction management module 366 controls user interactions with GPM output, such as, for example, the receiving and storing of user votes and comments. GPM aggregation/management module 368 controls the aggregation, organization and presentation of a plurality of GPMs, such as on a poll aggregation Web site. GPM search module 370 controls execution of searches of the GPM database.

Computer system 310 includes keyboard 312, processor 314, I/O interface 316, modem/NIC 318, display 320 and memory 322. Memory 322 may contain GPM output content 324. Computer system 310 represents, for example, the PC of a user of a GPM or a poll aggregation site.

Network device 330 includes processor 332, I/O interface 334, NIC 336, and memory 340. Memory 340 includes stored content 342, which, in turn, includes links to, and/or calls for, one or more GPMs 344. Network device 330 may be used as a server of a Web site publisher posting one or more links to GPMs on its site. It can also be used as a server of a poll aggregation Web site, where a number of GPMs relating to a variety of topics may be organized and presented.

Computer system 310 interacts with GPM server system 350 to: retrieve one or more GPMs, such as when rendering a Web page containing a GPM call such as, for example, stored content 342; execute user interactions with GPM output, such as user voting or continent submission; execute user actions to create a GPM; and/or execute a user search of a GPM database 380.

It is understood that while GPM server 350 and network device 330 are shown in FIG. 3 as two systems, the elements of GPM server 350 and network device 330 may reside on one or multiple computer systems in one or more locations.

Having discussed an exemplary system which implements the invention, the various methods of the invention will now be discussed.

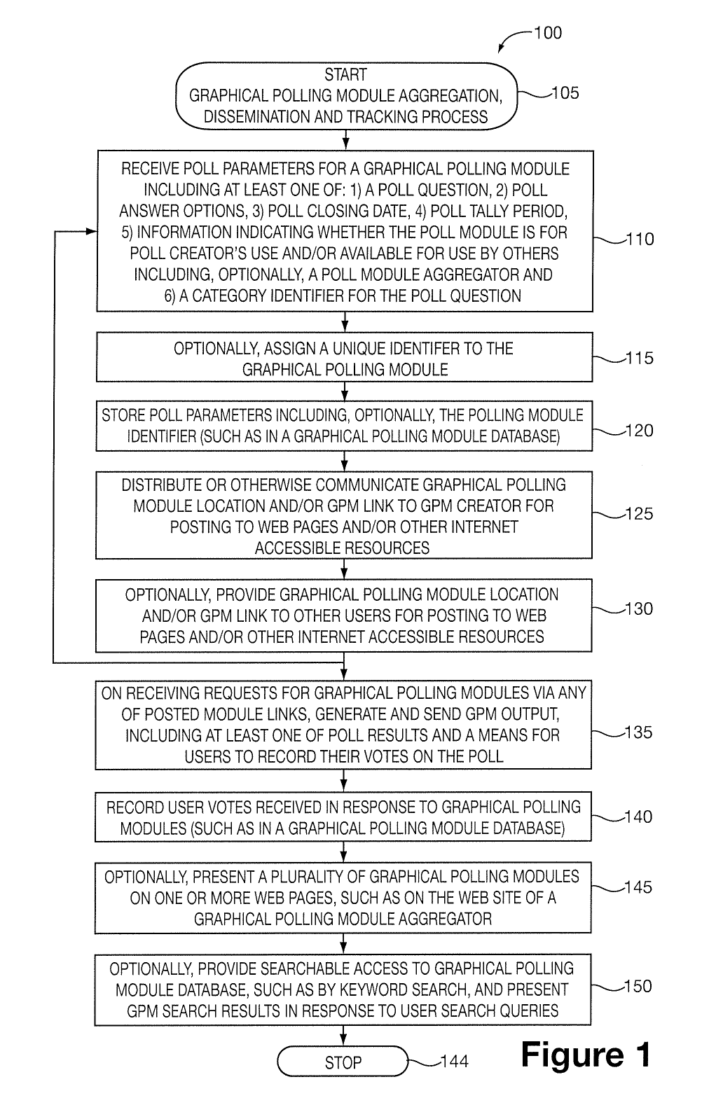

Referring now to FIG. 1, it can be seen that FIG. 1 illustrates an exemplary graphical polling module aggregation, dissemination and tracking method 100 of the invention. The method of flowchart 100 may be implemented by various modules in memory 360 of graphical polling module server 350 in FIG. 3, to be discussed later.

The GPM aggregation, dissemination and tracking process 100 begins in step 105, when one or more of GPM creation module 362, GPM rendering module 364, GPM interaction management module 366, GPM aggregation/management module 368 and/or GPM search module 370 are first loaded into processor 356 and executed, e.g., as part of the start-up process of graphical polling module server 350. Operation proceeds to step 10, in which one or more poll parameters are received, such as may result from execution of GPM creation module 362 initiated as a result of actions of a user of computer system 310. Poll parameters includes at least one of: 1) a poll question, 2) poll answer options, 3) poll closing date, 4) poll tally period, 5) information indicating whether the poll module is for the poll creator's use and/or available for use by others including, optionally, a poll module aggregator, and/or 6) a category identifier indicating the category of the poll question.

Proceeding to step 115, in step 115a unique identifier is, optionally, assigned to the graphical polling module. In step 120, one or more poll parameters including, optionally, the GPM category identifier is stored in memory such as, for example, in a GPM database. Proceeding to step 125, a GPM location and/or GPM link is sent or otherwise communicated to the GPM creator to facilitate posting of the GPM to Web pages, emails and/or other Internet accessible resources. In step 130, a GPM location and or GPM link is, optionally, sent or otherwise communicated to users other than the GPM creator, such as, for example, in response to a request by a user of a poll aggregation site.

From step 130, the process may return to step 110 and/or continue on to step 135. In step 135, on receiving requests for GPMs, such as may result from the posting of GPM links to Web sites, emails or other Internet accessible resources, GPM output, including at least one of poll results and a message or data structure for users to record their votes on the poll, is generated and sent to the requesting system. In step 140, user votes corresponding to GPMs are recorded and stored in memory, such as, for example, in a GPM database 380.

In step 145, optionally, a plurality of GPMs is presented on one or more Web pages, such as on the Web site of a polling module aggregator. In step 150, optionally, searchable access to GPMs is provided to users, such as by way of keyword search of a GPM database, and GPM search results are presented to users in response to their search queries. The process stops in step 144.

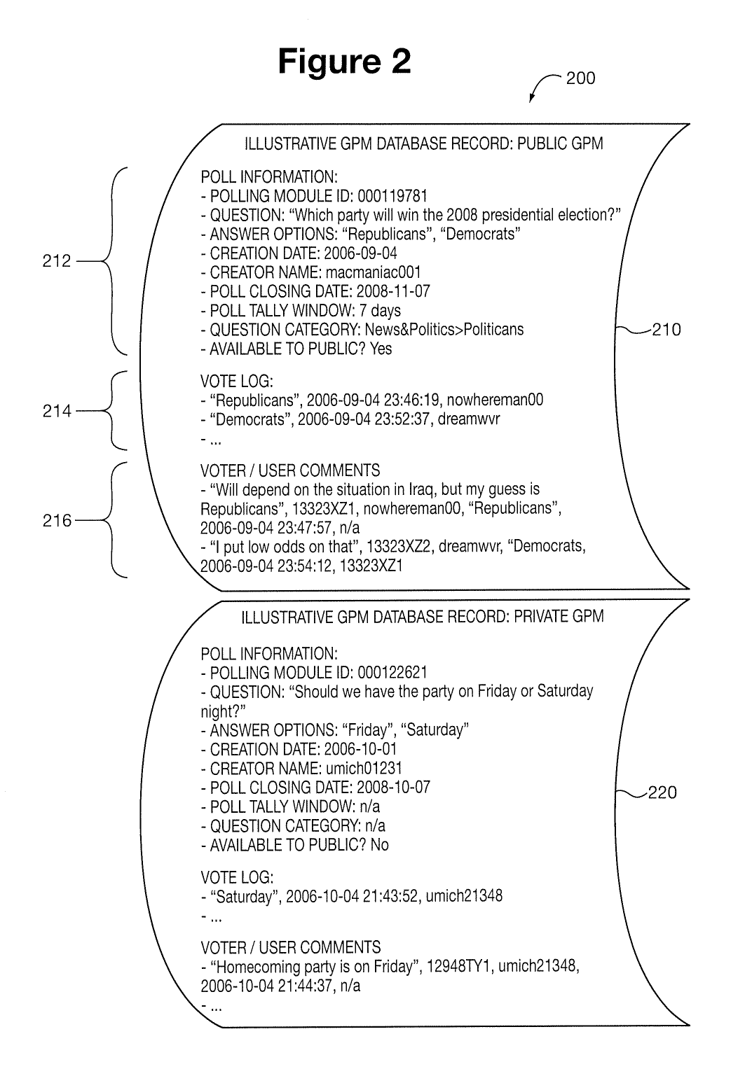

Drawing 200 of FIG. 2 illustrates two example GPM database records 210, 220. As shown in GPM database record 210, the GPM data structure may include: poll information 212, including a poll module ID, poll question, answer options, creation date, creator name, poll closing date, poll tally window, question category and information indicating whether the GPM may be made accessible to the public; vote log 214, which may include registered votes, times of votes, and voter usernames; and voter/user comments 216, which may include voter/user comments, comment IDs, usernames of comment submitters, votes registered on the corresponding poll by comment submitters, times of comment submissions, and/or comment IDs of comments that triggered current comments, such as to enable tracking of discussion threads.

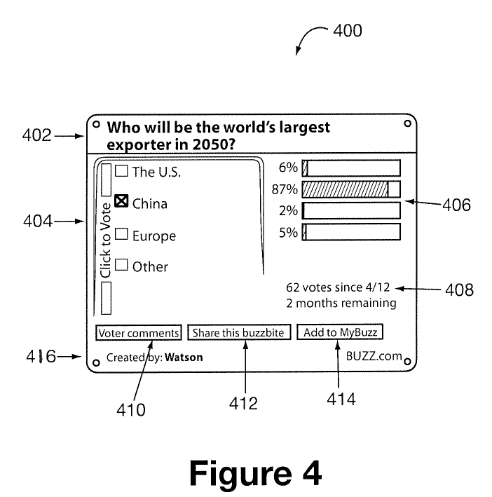

Exemplary screen displays, corresponding to various embodiments, which may be displayed on a user's computer system located at a customer premise are shown in FIGS. 4-15. Some embodiments include one or more of the following features. However, it should be noted that not all embodiments require or implement all the following features. Features which are supported in various embodiments include:
1) Simultaneous presentation of poll question/answers and results—Other polling services require users to vote before seeing results. In some embodiments the system provides a real-time “dashboard” experience by displaying poll questions/answers and results simultaneously.
2) Real-time poll updating is supported in various embodiments with the results reflecting voting results of a user community. The updating may be implemented, e.g., via communication with and the updating of poll results at a centralized polling server, e.g. utilizing ajax based methods or other result reporting and updating methods. In some embodiments poll results are updated on a regular or continuous basis based on voting activity across the user community. In this manner, a live-forum atmosphere not found on other polling sites, which generally feature static results as of the time of the user's vote, is created, providing an enhanced user experience and sense of belonging to a community.
3) The system may be implemented using self-contained, modular polling units and a related building-block/dissemination model. Graphical polling modules are used in some embodiments, as the building block of a polling results Web site and also the basis for the dissemination/aggregation model which is used in some embodiments.
4) The system supports and provides in some embodiments an assembly of polling modules which is a searchable, navigable collection of polling modules that forms a Web destination where individuals can vote on, view, and comment on issues spanning a wide variety of topics.
5) Some features are directed to a GPM management system. In some embodiments a content management system is provided. The system is designed to, and in various embodiments does, perform one or more of: accepting, managing and presenting collections of graphical polling modules.
6) In accordance with one feature of the invention, sponsorship information if stored and associated with individual polling modules. Advertisements and/or links to advertisements provided by the sponsor are stored. Thus, sponsorships can, and in some embodiments are, attached to, or otherwise associated and/or displayed with, individual GPMs. A management system and revenue generation method is implemented in some embodiments, e.g., on the polling server, whereby a particular advertiser/sponsor is associated with a relevant GPM and featured through a continuously-displayed or drop-down digital ad unit. User selection, voting and/or viewing of a poll question or poll result corresponding to a sponsor is detected and may be used to trigger display of the corresponding advertisement and/or used to trigger presentation of a link to the sponsoring advertisers ad.

Voting histories are maintained on a per user basis in some embodiments. Such voting histories are used, in some embodiments, to target ads directed to individual users. The ads which are targeted using the voting history, may be displayed on a page showing polling results and/or on other web pages visited by the user. In such embodiments, the user's computer system may provide information indicating which web sites are visited and/or the content of web sites which are visited. The stored polling results corresponding to the computer system and/or specific user associated with the information which is provided is used in combination with the polling results to select advertisements for display. For example, is stored polling results indicate a user's preference for cats as a pet over dogs, when visiting a web site about pets or animals, advertisements or links to advertisements about cats might be selected and provided to the user's computer system for display. Also consider for example if a user's past polling results indicated a preference for a particular type of loan, e.g., an adjustable rate mortgage over a fixed rate mortgage. In one such embodiment, the stored preference information corresponding to a user or computer system might be used to trigger the selection of loans corresponding to the user preferred type known from past polling information.

In some embodiments ads and/or sponsorships of polling modules are based on one or more of the following: a user's voting history alone or in combination with other information about the user to which the ad is to be presented or other users. Examples of vote based advertisement targeting approaches which may, and in some embodiments are, used in accordance with the invention include:
targeting based on user's vote on one or multiple GPMs, potentially in combination with other information about the user
targeting based on user's own voting history and information only or on analysis of voting/ad response patterns across the broader user population (e.g. using collaborative filtering techniques)
application both to registered and anonymous (i.e. unregistered) users
application both on the polling webs site presenting polling and voting results in accordance with the invention as well as on other sites the identified user may visit.

FIG. 4 is a drawing of an exemplary Graphical Polling Module (GPM) 400, sometimes referred to as a “buzzbite”. The exemplary GPM 400 is a self-contained polling module which forms the building block of a polling web site and is also the basis for the dissemination/aggregation model core to the service's distribution module. In some embodiments the distribution module may have self-replicating capabilities. However, such replication would normally be with the consent of the system user, e.g., after the user was presented with information about the distribution process. Exemplary Graphical Polling Module 400 includes a poll question portion 402, a clickable answer option portion 404, a real-time poll results portion 406, a poll status portion 408, a voter comments button 410, a share button 412, a personalized tracking page button 414, and a poll creator portion 416. Poll question portion 402 displays the poll question corresponding to the GPM 400, e.g., “Who will be the world's largest exporter in 2050?”. Clickable answer option portion 404 lists and displays the clickable options which can be selected in response to the poll question of portion 402, and following a selection, the clickable answer option section also displays the selection. In this example, the four options are: The U.S., China, Europe, and other; the selected option is China. When an option is selected, the clickable answers option immediately reflects the user's vote. The real-time poll results portion 406 displays real-time poll results, continuously updating the results to reflect votes of this user and of other users voting on this poll. In this example, the real time poll results are displayed in bar graph format illustrating percentages associated with each of the answer options. Poll status portion 408 includes information identifying the number of votes, the start date of the poll, and time remaining until the end of the poll. Voter comments button 410 allows the user to access a discussion board regarding the poll. Share button 412 allows the user to share this buzzbite, e.g., allows the user access to options to email the GPM or post the GPM to other sites. Personalized tracking button 414 allows the user the option to Add or remove the poll to/from a personalized poll tracking page referred to as “MyBuzz”. Poll creator portion 416 identifies the creator of the poll.

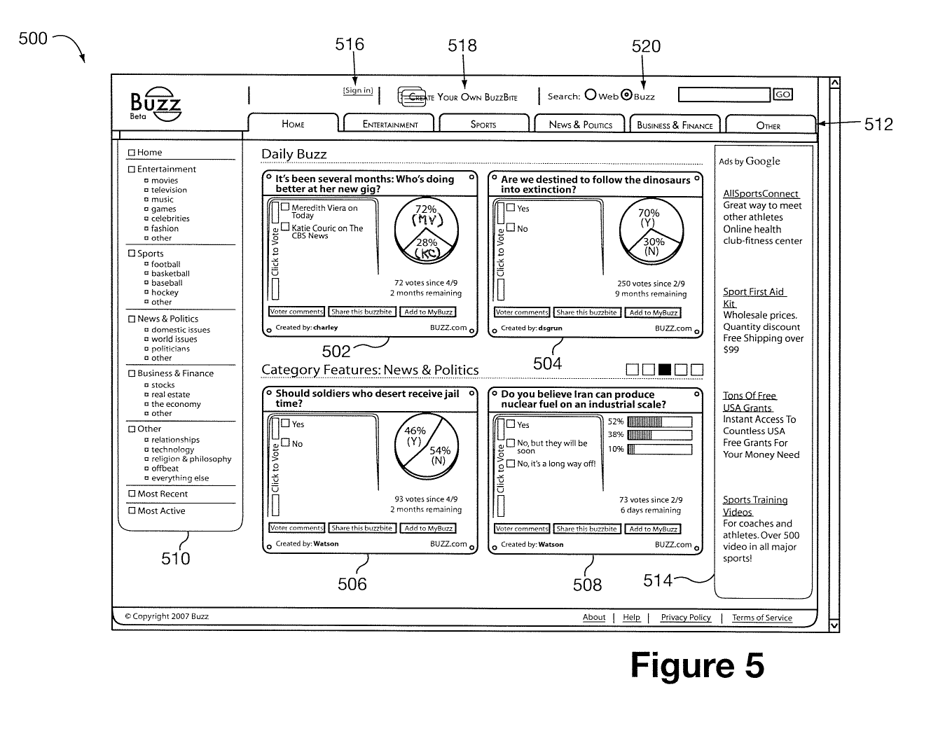

FIG. 5 is a drawing 500 of an exemplary Home page in an exemplary initial state. Exemplary initial state Home page 500 includes a plurality of graphical polling modules (502, 504, 506, 508), a index section in list format 510, and index section in tab format 512, an advertising section 514, a log-in section 516, a creation section 518 for creating your own BuzzBite, and a search section 520. In this example, two of the polling modules (502, 504) correspond to a Daily Buzz section, while two of the polling modules (506, 508) pertain to a specific category, which in this example is News & Politics. In this example, the user has not yet voted on any of the displayed GPMs, and the Home page is displayed in an initial state with no identified user selections being identified as registering a vote.

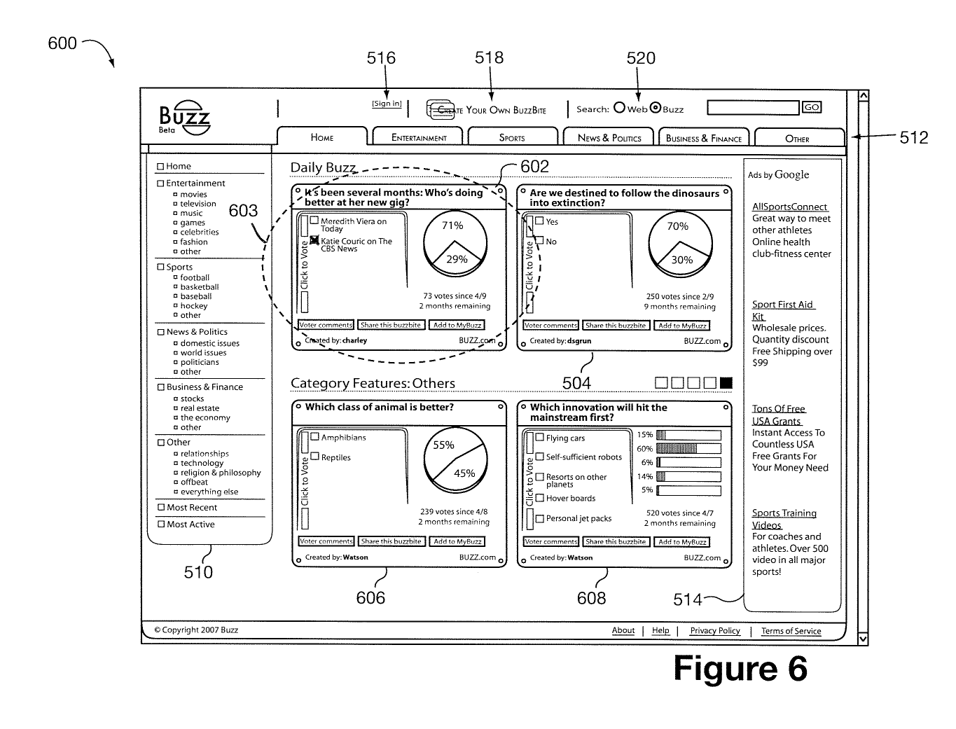

FIG. 6 is a drawing 600 of an exemplary Home page corresponding to a second state. Exemplary Home page 600 is modified variation of initial state Home page 500. Exemplary Home page 600 includes a plurality graphical polling modules (602, 504, 606, 608). Exemplary GPM 602 is a representation of GPM 502 of FIG. 5 following a user's decision to vote on the GPM of the tipper left corner identified by dash lined oval 603. In this example, the user has selected to vote for Katie Couric, and the GPM immediately reflects the user's choice by highlighting the selected answer option and updating the graphical and text voting results. The pie chart of changed from a 72%/28% display in GPM 502 of FIG. 5 to a 71%/29% display in GPM 602 of FIG. 6. In addition the number of counted votes changed from 72 in GPM 502 of FIG. 5 to 73 in GPM 602 of FIG. 6. Note that in FIG. 6, the category features has changed to “Others” resulting in two new GPMs (606, 608). The change to the new category features can be from a user selection or from an automated change.

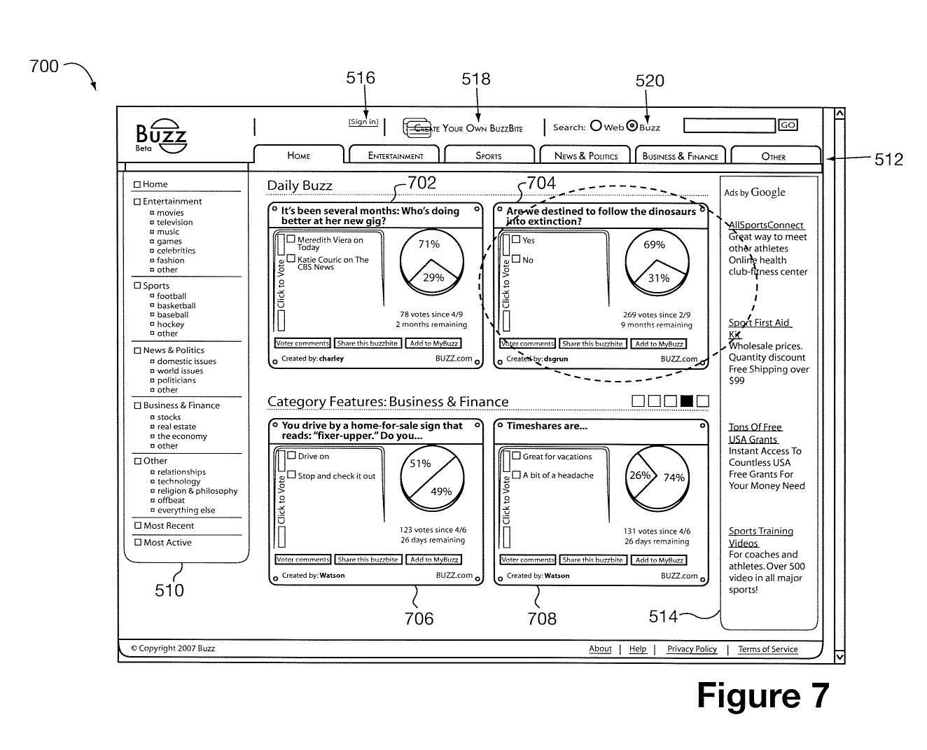

FIG. 7 is a drawing 700 of an exemplary Home page corresponding to a third state. Exemplary Home page 700 is modified variation of initial state Home page 500. Exemplary Home page 700 includes a plurality graphical polling modules (702, 704, 706, 708). Exemplary GPM 702 is a representation of GPM 502 of FIG. 5 reflecting votes of other users; exemplary GPM 704 is a representation of GPM 504 of FIG. 5 reflecting votes of other users. Note that in GPM 702 the number of votes is 78, while in GPM 502 the number of votes is 72, and in GPM 702, the pie graph indicates a 71%/29% split, while in GPM 502 the pie graph indicates a 72%/28% split. In GPM 704 the number of votes is 269, while in GPM 504 the number of votes is 250, and in GPM 704, the pie graph indicates a 69%/31% split, while in GPM 504 the pie graph indicates a 70%/30% split. Note that in FIG. 7, the category features has changed to “Business and Finance” resulting in two new GPMs (706, 708). The change to the new category features can be from a user selection or from an automated change.

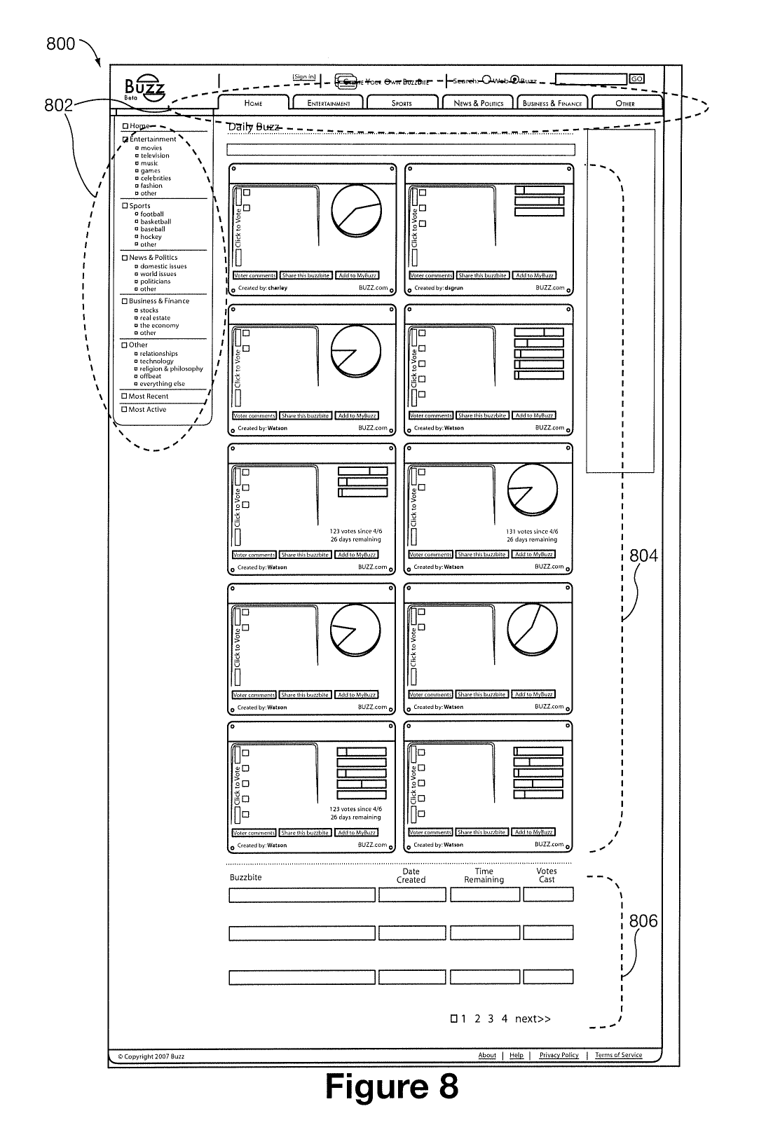

FIG. 8 is a drawing 800 illustrating exemplary site GPM navigation structure 802, an editorially managed GPM features section 804, and an auto-generated GPM list 806. FIG. 8 illustrates that GPMs are organized by category and are manually and automatically managed to create a searchable, navigable collection of polls spanning a wide variety of topics.

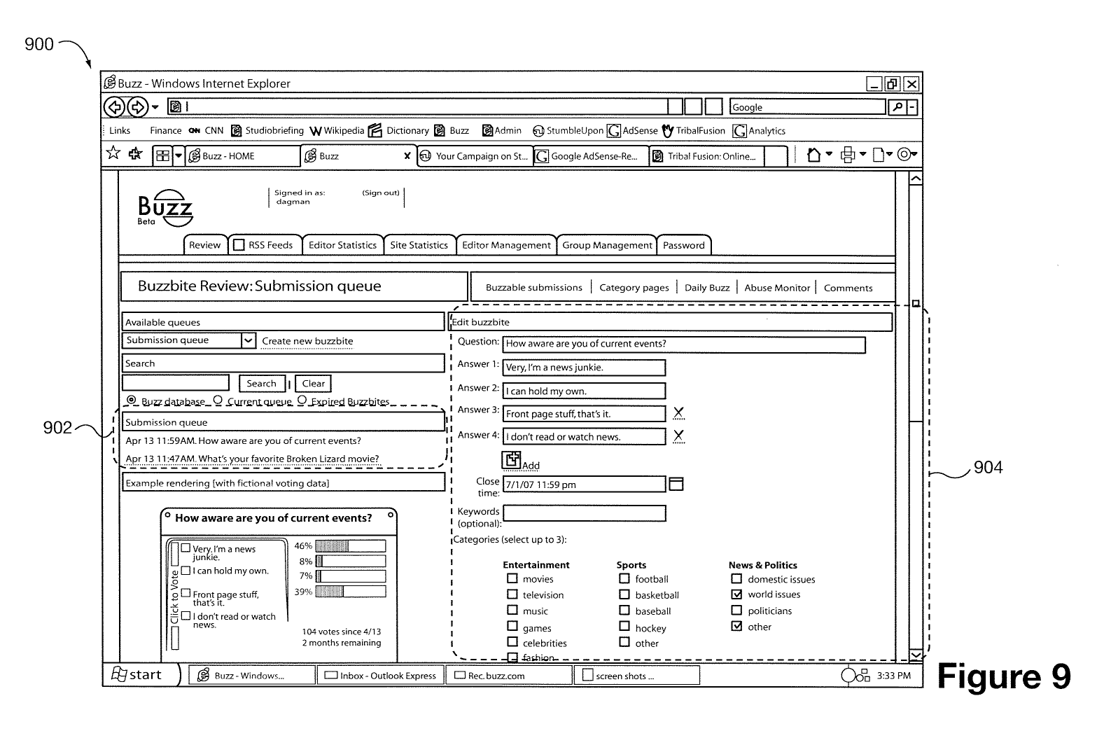

FIG. 9 is a drawing of an exemplary Web page 900 illustrating that the GPM management system provides the ability to filter and edit GPMs submitted by users and editors. It includes submission queue 902 containing GPM submissions from users and/or editors available for review by an editor, and a GPM review and edit area 904 in which an editor can review and edit the GPM question, answer options and other GPM parameters; add identifying keywords to facilitate search of the GPM database; and approve or reject the GPM.

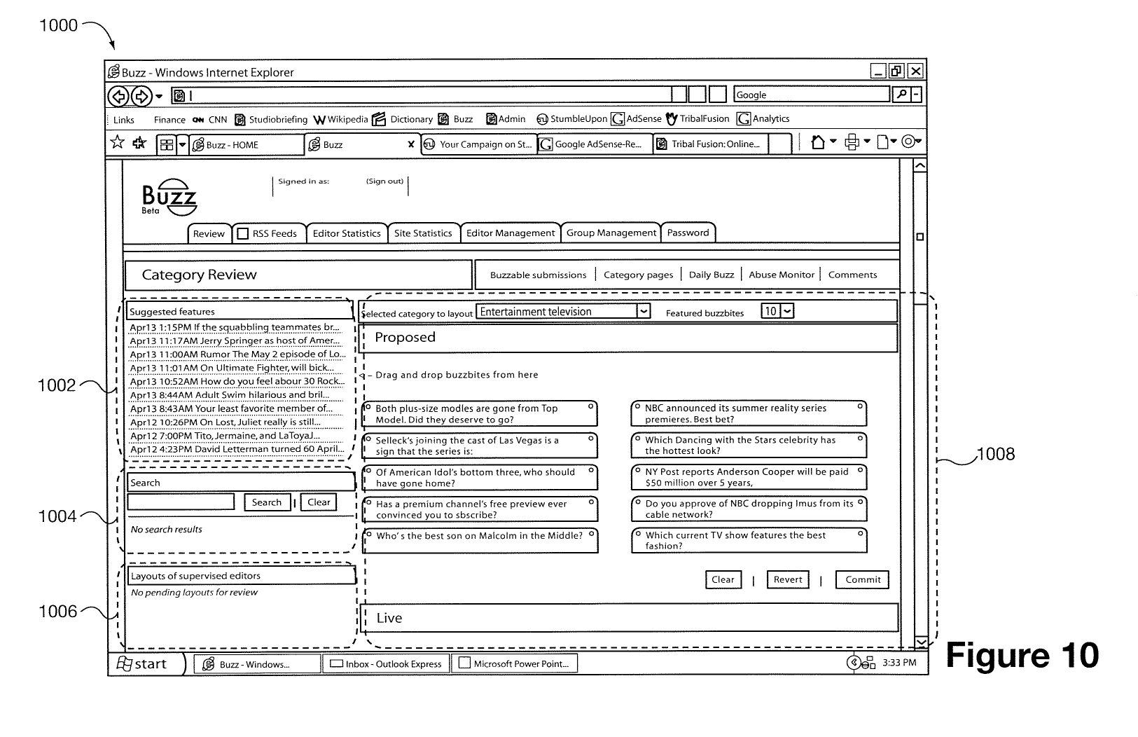

FIG. 10 is a drawing of an exemplary Web page 1000 illustrating that the GPM management system provides the ability to organize GPMs featured on each page of a site. It includes suggested features area 1002 containing GPMs flagged as potential GPM features by submission review editors, search function 1004 enabling an editor to search the GPM database for other potential GPM features, and pending layouts area 1006 containing a list of proposed feature-page layouts prepared by editors and awaiting review and approval by a managing editor. It also includes layout review and edit area 1008 in which a managing editor can review, edit and approve or reject proposed GPM feature-page layouts.

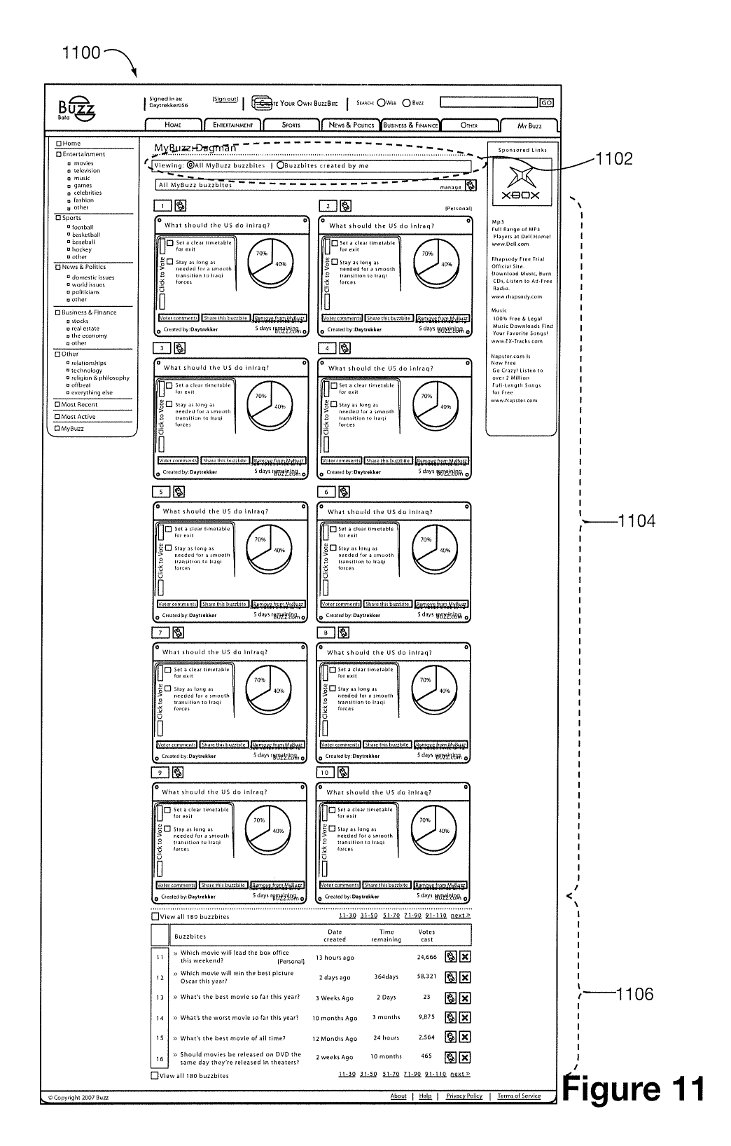

FIG. 11 is a drawing of an exemplary Web page 1100 illustrating a personalized GPM tracking feature, e.g., the “MyBuzz” feature, enabling a user to track GPMs of interest in a single area of the site. It includes viewing mode selector 1102 that enables a user to select between displaying the GPMs designated to be of interest by said user or just GPMs created by said user. It also includes graphical GPM area 1104 showing the top GPMs among those in the selected viewing mode, and GPM list area 1106 listing other GPMs among those in the selected viewing mode.

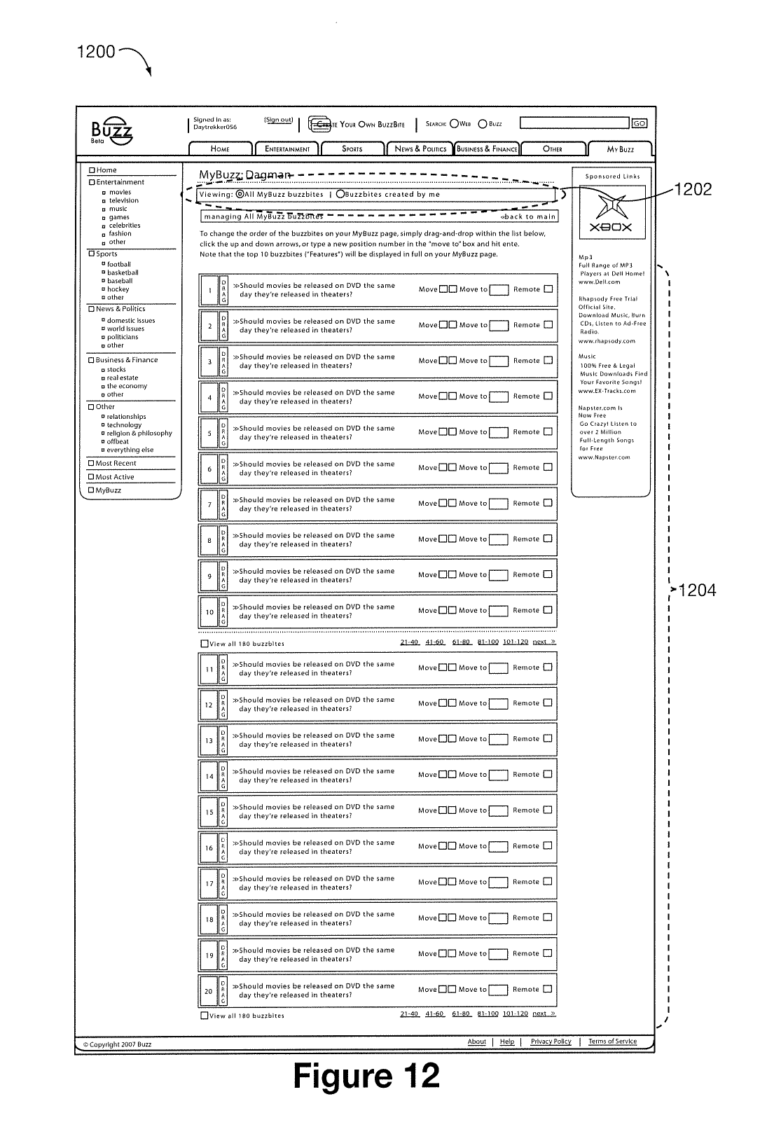

FIG. 12 is a drawing of an exemplary Web page 1200 illustrating a personalized GPM tracking feature, e.g., “MyBuzz” feature, enabling the user to manage, e.g., re-order and/or remove, the GPMs included in the personalized area. It includes viewing mode selector 1202 that enables a user to select between managing the GPMs designated to be of interest by said user or just GPMs created by said user. It also includes GPM list 1204 listing the GPMs associated with the selected viewing mode as well as movement/removal control features with each.

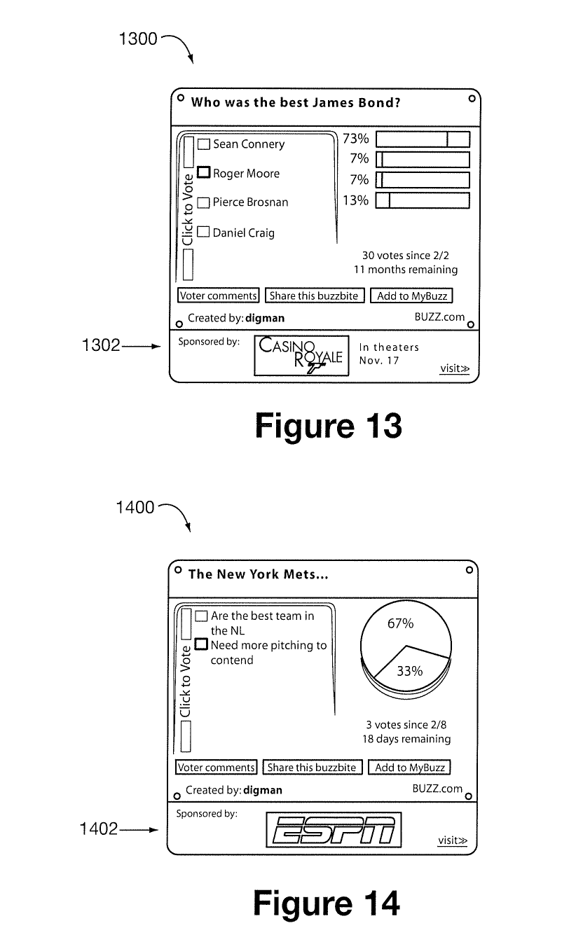

FIG. 13 and FIG. 14 are examples of sponsored GPMs 1300, 1400, respectively. Exemplary GPM 1300 pertaining to a movie includes a sponsorship portion 1302 identifying that the GPM is sponsored by an entity advertising the movie Casino Royale. Exemplary GPM 1400 pertaining to a sports question includes a sponsorship portion 1402 identifying that the GPM is sponsored by ESPN. Advertisements and/or sponsorships can be, and sometimes are, associated with individual GPMs. In some embodiments, the advertisement and/or sponsorship information appears on a mouse-rollover. In some embodiments, the advertisements and/or sponsorships are tailored to the specific content of the poll. In various embodiments, the advertisements and/or sponsorship information is associated with individual GPMs and with individual users or groups of users. For example, information about a user may be, and sometimes is, utilized to select the advertisement to be directed to the user. Thus advertisers and/or sponsors can target select groups or individuals.

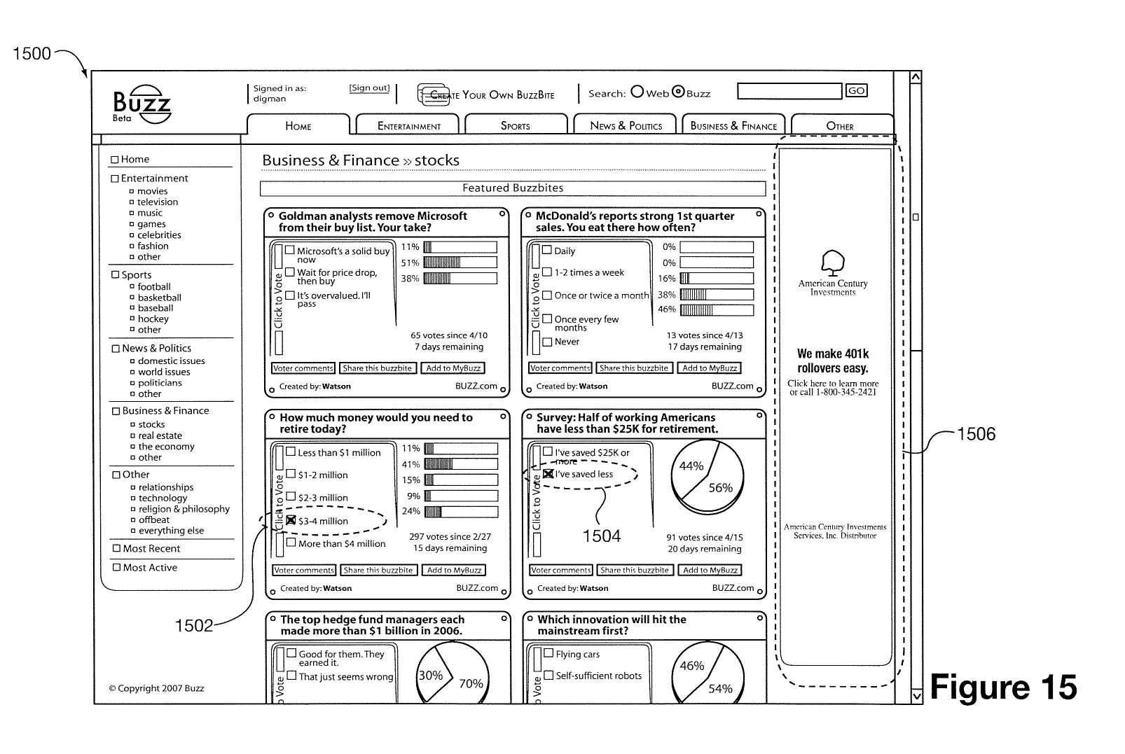

FIG. 15 is a drawing illustrating a feature that ads and/or sponsorship may be, and sometimes are, targeted based on a user's voting history. In some embodiments, ads and/or sponsorship are based on a user's voting history in combination with other information about the same user or other users. Some such vote-based targeting methods include one or more of: i) targeting based on a user's vote on one or multiple GPMs, ii) targeting based on a user's own voting history only or on analysis of voting and/or ad response patterns across user populations, e.g., using collaborative filtering techniques, iii) application to registered users; iv) application to anonymous users, e.g., unregistered users; v) application to both registered and anonymous users; vi) application both on the BuzzDash site as well as on other sites the identified user may visit. In the example of FIG. 15, assume that the user has responded to two polls in the Business and Finance section as indicated by selected votes 1502 and 1504. Such vote information is utilized in determining targeted ad 1506 which is placed on the Web page display for the user.

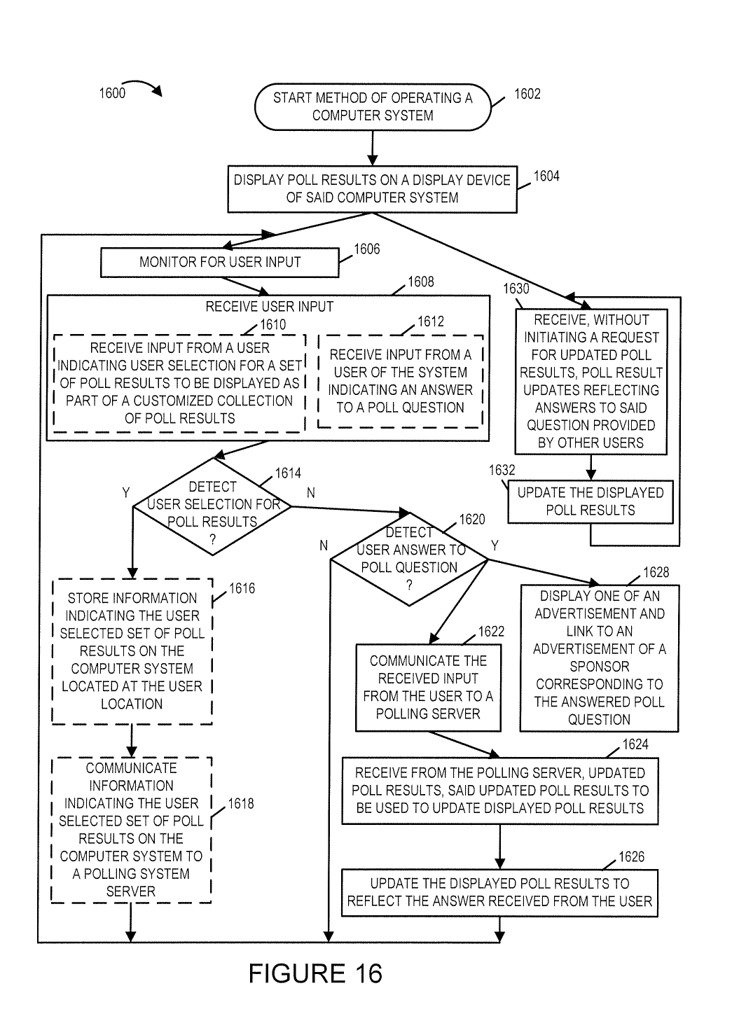

FIG. 16 is a flowchart 1600 of an exemplary method of operating a computer system in accordance with various embodiments. Operation starts in step 1602, where the computer system is powered on and initialized and proceeds from step 1602 to step 1604. In step 1604, the computer system displays poll results on a display device of the computer system. In various embodiments, displaying poll results includes displaying poll questions and corresponding poll answer results simultaneously. In various embodiments, the poll questions and answers are displayed for a poll question to which the user of the system may, and sometimes does, indicate and answer prior to the user providing the answer. In some embodiments, the displayed poll results are a collection of poll results corresponding to a plurality of different polling questions. In some embodiments, displaying of poll results is performed as part of displaying a Web page including a collection of polling results. In some such embodiments, the Web page is one of a plurality of Web pages including polling results arranged according to a topic relating to poll question and results displayed on the Web page. In some embodiments, during at least some times, displaying of poll results is preformed as part of displaying a customized Web page including a collection of polling results, said selection of poll results having been selected by said user as part of a step of creating a user customized Web page of poll results. Operation proceeds from step 1604 to step 1606 and 1630.

In step 1606, the computer system monitors for user input, and in step 1608 the computer system receives user input. At times step 1608 includes one of sub-step 1610 and sub-step 1612. In sub-step 1610, the computer system receives input from a user indicating user selection for a set of poll results to be displayed as part of a customized collection of poll results. In sub-step 1612, the computer system receives input from a user of the system indicating an answer to a poll question. Operation proceeds from step 1608 to step 1614.

In step 1614, the computer system determines whether or not it has detected user selection for a set of poll results. If it has detected user selection for poll results from the received user input of step 1608, then operation proceeds to the path including steps 1616 and 1618; otherwise operation proceeds from step 1614 to step 1620. In some embodiments, one of steps 1616 and 1618 is included. In some embodiments both of steps 1616 and 1618 are included. The flow description will now be described with respect to an embodiment including both steps 1616 and 1618. In other embodiments the omitted step may be bypassed. In step 1616, the computer system stores information indicating the user selected set of poll results on the computer system located at the user location. Operation proceeds from step 1616 to step 1618. In step 1618, the computer system communicates information indicating the user selected set of poll results on the computer system to a polling system server. In some embodiments, information indicating the user selected set of poll results to be included in a customized collection of poll results is stored on a polling system server coupled to the computer system located at the user location, said coupling including coupling via the Internet. Operation proceeds from step 1618 to step 1606 for additional monitoring for user input.

Returning to step 1620, in step 1620 the computer system determines whether or not it has detected a user answer to a poll question from the received user input of step 1608. If it has detected a user answer to a poll question from the received user input of step 1608, then operation proceeds from step 1620 to steps 1622 and 1628; otherwise operation proceeds from step 1620 to step 1606 to monitor for additional user input.

Returning to step 1622, in step 1622 the computer system communicates the received input from the user to a polling server, and then in step 1624, the computer system receives, from the polling server, updated poll results, the updated poll results to be used to update the displayed poll results. Operation proceeds from step 1624 to step 1626. In step 1626, the computer system updates the displayed poll results to reflect the answer received from the user. In various embodiments, during at least some times, updating reflects results of answers received from a plurality of users which are permitted to provide answers to said questions. In some such embodiments the plurality of users are part of a user community which are permitted to vote on a poll question. In some embodiments, the updated poll results include poll answers received from other users in addition to said users, said other users being located at different locations than said user. Operation proceeds from step 1626 to step 1606 for additional monitoring for user input.

Returning to step 1628, in step 1628 the computer system displays one of an advertisement and link to an advertisement of a sponsor corresponding to the answered poll question.

Returning to step 1630, in step 1630, the computer system receives, without initiating a request for updated poll results, poll result updates reflecting answers to said questions provided by other users. Operation proceeds from step 1630 to step 1632. In step 1632, the computer system updates the displayed poll results. Operation proceeds from step 1632 to step 1630 to receive additional poll result updates.

In some embodiments, the steps of displaying receiving and updating, e.g., steps 1604, step 1608, and step 1626 are performed by a computer system located at a user location, said computer system including a display and an input device for receiving said user input.

In various embodiments, the step of receiving user input and updating the displayed results is performed in real time.

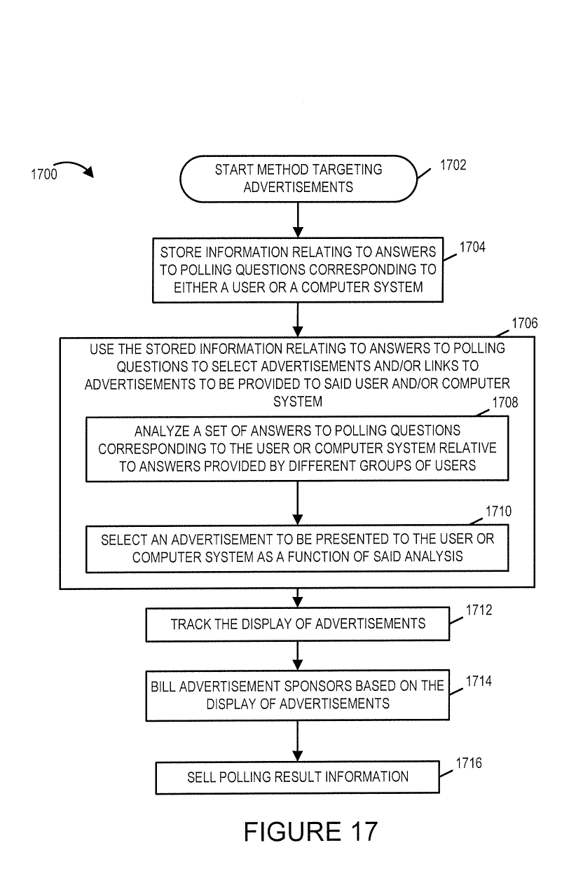

FIG. 17 is a flowchart 1700 of an exemplary method of targeting advertisements in accordance with various embodiments. Operation starts in step 1702, where initialization occurs and proceeds to step 1704.

In step 1704, information is stored relating to answers to polling question corresponding to either a user or a computer system. Operation proceeds from step 1704 to step 1706.

In step 1706, the stored information relating to answers to polling question is used to select advertisements and/or links to advertisements to be provided to said user and/or computer system. Step 1706 includes sub-steps 1708 and 1710. In sub-step 1708 a set of answers to polling questions corresponding to the user or computer system are analyzed relative to answers provided by different groups of users. Operation proceeds from sub-step 1708 to sub-step 1710. In sub-step 1710 a selection is performed of an advertisement to be presented to the user or computer system as a function of said analysis.

In some embodiments, selecting an advertisement includes selecting an advertisement known to have been of interest to members of a group of users having a similar voting history to said user or computer system. In some such embodiments, at least some of said group of users are groups defined by user characteristics at least some of which are non-voting history characteristics. In some embodiments, collaborative filtering is used in at least one of said analyzing and selecting steps. In various embodiments, the advertisements are selected as a function of information corresponding to a Web site being visited in addition to the answers to previous polling results. In some embodiments, the method also includes using information on a collection of polling results being displayed to select an advertisement or link to an advertisement.

Operation proceeds from step 1706 to step 1712. In step 1712, the display of advertisements is tracked, and in step 1714 the advertisement sponsors are billed based on the display of advertisements. Operation proceeds from step 1714 to step 1716. In step 1716 the polling result information which has been tracked and collected is sold. In some embodiments, the polling result information is sold to advertisers for use by said advertisers in selecting advertisements to be displayed.

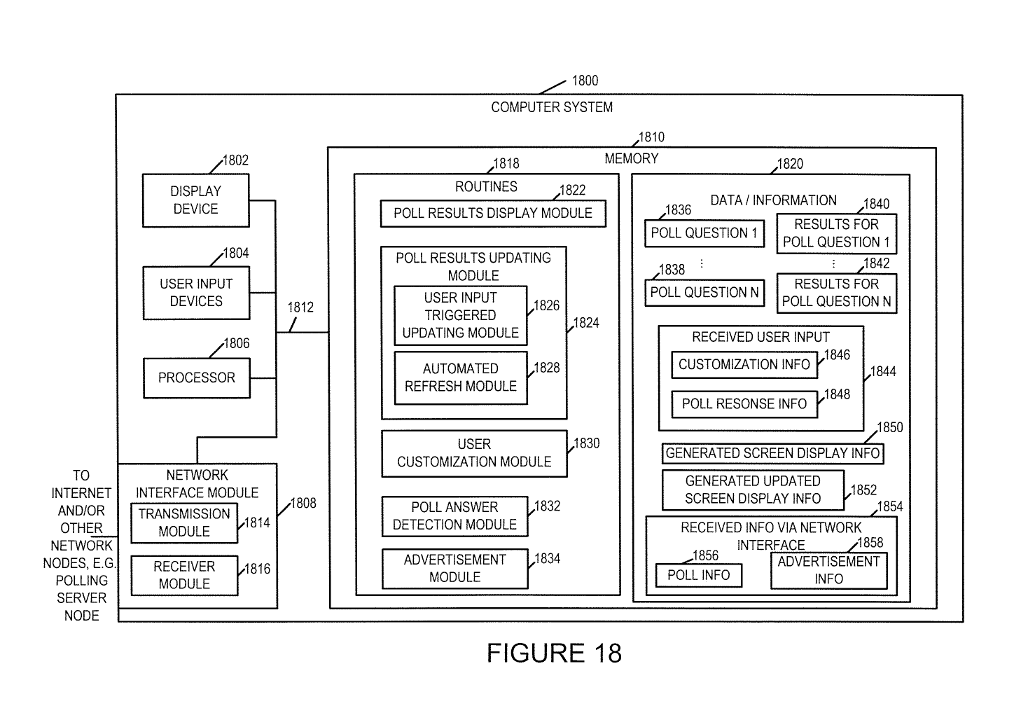

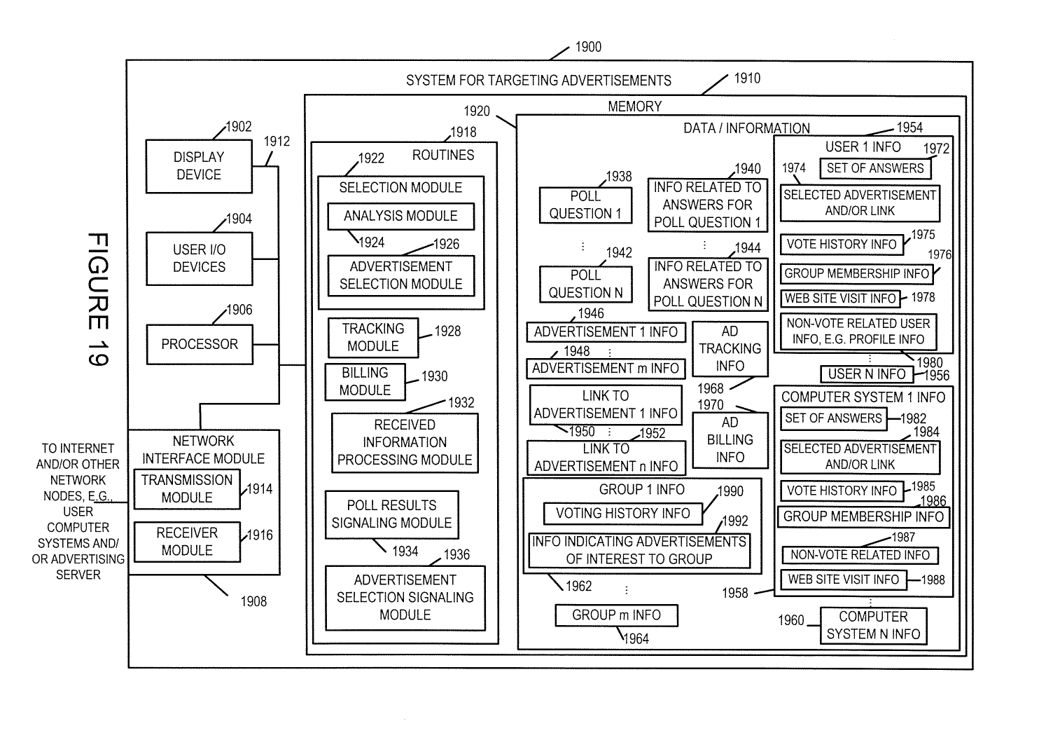

FIG. 18 is a drawing of an exemplary computer system 1800 in accordance with various embodiments of the present invention. Exemplary computer system 1800 includes a display device 1802, user input devices 1804, a processor 1806, a network interface module 1808, an memory 1810 coupled together via a bus 1812 over which the various elements may interchange data and information.

Memory 1810 includes routines 1818 and data/information 1820. The processor 1806, e.g., a CPU, executes the routines 1818 and uses the data/information 1820 in memory 1810 to control the operation of the computer system 1800 and implement methods, e.g., the method the of flowchart 1600 of FIG. 16.

Routines 1818 include a poll results display module 1822, a poll results updating module 1824, a user customization module 1830, a poll answer detection module 1832 and an advertisement module 1834. Poll results updating module 1824 includes a user input triggered updating module 1826 and an automated refresh module 1828.

Data/information 1820 includes a stored information corresponding to a plurality of sets of poll questions and corresponding results ((poll question 1 1836, results for poll question 1 1840), . . . , (poll question N 1838, results for poll question N 1842), received user input 1844 including customization information 1846 and poll response information 1848, generated screen display information 1850, generated updated screen display information 1852, and received information via a network interface 1854. The received information via a network interface 1854 includes poll information 1856 and advertisement information 1858. Poll results and poll answers, e.g. information 1836 and 1840, are displayed simultaneously on a screen of display device 1802. In various embodiments, a poll question and a corresponding poll result is displayed for at least one poll question to which the user of the system indicates an answer prior to the user providing an answer.

Network interface module 1808 couples the computer system 1800 to the Internet and/or other network nodes, e.g., a polling server node. Network interface module 1808 connects the computer system to a plurality to additional computer systems corresponding to other users, said other users being part of a group of user community members which are permitted to vote on said poll question. Network interface module 1808 includes a transmission module 1814 and a receiver module 1816. Transmission module 1814 communicates information from computer system 1800 to other network nodes. Transmission module 1814 communicates received input from a user to a polling server. Receiver module 1816 receives from a polling server updated poll results, said received updated poll results being used by the poll results updating module 1824 to update the displayed poll results in real time.

Display device 1802 is, e.g., a CRT, flat screen display, LCD display, or other technology display device. Display device 1802 displays generated displays to a user. Generated displays include, e.g., user displays such as those described with respect to FIGS. 4-15. At least some of the generated displayed screens include a poll question portion, a poll question selection potion and corresponding poll results portion. Displayed poll results are, at times, a collection of poll results corresponding to a plurality of different polling question. Various generated display screens include an advertisement and/or sponsor display portion.

User input devices 1804 includes, e.g., mouse, keyboard, keypad, etc. A user input device 1804 receives input from a user of the system 1800 indicating an answer to a poll question. Other information received via a user input device 1804 include, e.g., log-in information, user Web page customization information, user input used for a proposal for generating a poll module, user selection of poll modules to display, and user background profile information.

Poll results display module 1822 displays poll results on the display device 1802. Poll results updating module 1824 updates displayed poll results. Poll results updating module 1824 updates poll results to reflect an answer to a poll question received from the user of computer system 1800. Poll results updating module 1824 also updates poll results to reflect answers to poll results received from other users. For example, poll results updating module 1824 updates displayed poll results to reflect results of answers received from a plurality of users which are permitted to provide answers to a displayed question. Poll results updating module 1824 includes a user input triggered updating module 1826 and an automated refresh module 1828. User input triggered updating module 1826 performs updating to the poll resulting display in response to a poll answer initiated by a user of computer system 1800. Automated refresh module 1828 performs updating of displayed poll results, e.g., reflecting changes to poll results from input from other users of different computer systems which are coupled to the same polling server node which is serving computer system 1800. Automated refresh module 1828 updates poll results automatically to reflect answers to poll questions, said answers including answers received from other users located at different locations.

Poll results updating module 1824 operates to update displayed results in real time based on user input. Updated poll results can, and sometimes do, include poll answers received from other users in addition to the user of computer system 1800, said other users being located at different location than the user of computer system 1800.

User customization module 1830 receives user poll selection information and displays a customized collection of poll results to be displayed as a group.

Poll answer detection module 1832 detects that a user of device 1800 has decided to answer a displayed poll question, e.g., module 1832 detects that a user has clicked on an answer question box. In various embodiments, a detection by poll answer detection module 1832 is used as a trigger by user input triggered updating module to initiate a poll updating process to be performed.

Advertisement module 1834 identifies and/or installs advertisements and/or sponsorship information to be displayed on the user display, e.g., in conjunction with poll module displays. In various embodiments, the advertisement module 1834 implements a targeted advertisement display decision, the selected targeted advertisement be targeted to the particular user of computer system 1800. Advertisement information 1858 received via network interface module 1808, e.g., from a polling server node, includes, e.g., an advertisement and/or information identifying a particular advertisement to be displayed as part of targeted advertising.

Stored poll question and results information (1836, 1840, 1838, 1842) includes information used by poll results display module 1822 and poll results updating module 1824 to display current polling information. Received user input 1844 includes user input received via user input devices 1804. Customization information 1846 includes information identifying a set of poll modules that the user of computer system 1800 has selected to be displayed on the user's customized display page. Customization information 1846 also includes log-in information, user profile information, and user proposals for user generated or modified poll modules. Poll response information 1848 includes answers to poll question input by the user of computer system 1800.

Generated screen display information 1850 includes, e.g., information generated by poll results display module which is fed to display device 1802 to generate a display. Generated updated screen display information 1852 includes, e.g., information generated by poll results updating module 1824 which is fed to display device 1802 to update a generated display.

FIG. 19 is a drawing of an exemplary system for targeting advertisements 1900 in accordance with various embodiments of the present invention. System 1900 is, e.g., a polling server node. Exemplary system 1900 includes a display device 1902, user I/O devices 1904, a processor 1906, a network interface module 1908, and a memory 1910 coupled together via a bus 1912 over which the various elements may interchange data and information.

Memory 1910 includes routines 1918 and data/information 1920. The processor 1906, e.g., a CPU, executes the routines 1918 and uses the data/information 1920 in memory 1910 to control the operations of the system 1900 and implement methods, e.g., the method of flowchart 1700 of FIG. 17.

Network interface module 1908 couples the system 1900 to the Internet and/or to other network nodes, e.g., user computer systems 1800 and/or an advertising server node or nodes. Network interface module 1908 includes a transmission module 1914 and a receiver module 1916. Receiver module 1916 receives information from user computer systems such as identification information, user vote information, profile information, Web site information. Receiver module 1916 also receives information from nodes associated with advertisers, e.g., an advertisement, a link to an advertisement, and information identifying criteria to be used to target a customer to be presented with the advertisement or link. Receiver module 1916 also, in some embodiments, receives confirmation information of display by a user computer system of a selected advertisement and/or information indicating that a user has selected to access a presented advertised link. Transmission module 1914 transmits information to user computer systems, e.g., updated poll results information and advertisement information, e.g., a advertisement, an advertisement link or information identifying a advertisement or link. This can be, and sometimes is, on a user or computer system basis. For example, a first user or first user computer system is targeted to receive a different advertisement display than a second user or second user computer system. Transmission module 1914 also transmits billing information to an advertiser's node for billing charges pertaining to presented targeted advertisements and/or presented targeted links.

Routines 1918 includes a selection module 1922, a tracking module 1928, a billing module 1930, a received information processing module 1932, a poll result signaling module 1934, and an advertisement selection signaling module 1936. Data/information 1920 includes a plurality of sets of poll question and information related to answers for poll questions ((poll question 1 1938, information relating to answers for poll question 1 1940), . . . , (poll question N 1942, information related to answers poll question N 1944), a plurality of stored advertisements (advertisement 1 information 1946, . . . , advertisement in information 1948), and a plurality of links to advertisements (link to advertisement 1 information 1950, . . . , link to advertisement n information 1952). Data information 1920 also includes a plurality of sets of user information (user 1 information 1954, . . . , user N information 1956), a plurality of set of computer system information (computer system 1 information 1958, . . . , computer system N information 1960), and a plurality of sets of group information (group 1 information 1962, . . . , group m information 1964). Data/information 1920 also includes advertisement tracking information 1968 and advertisement billing information 1970.

User 1 information 1954 includes a set of answers 1972, a selected advertisement and/or link 1974, vote history information 1975, group membership information 1976, Web site visit information 1978, and non-vote related information, e.g., user profile information 1980.

Computer system 1 information 1958 includes a set of answers 1982, selected advertisement and/or link 1984, vote history information 1985, group membership information 1986, non-vote related information 1987, and Web site visit information 1988.

Group 1 information 1962 includes voting history information 1990 and information indicating advertisements of interest to the group 1992.

Selection module 1922 selects at least one of: i) an advertisement and ii) a link to an advertisement to be provided to a user or a computer system based on stored information relating to polling questions. Selection module 1922 includes an analysis module 1924 and an advertisement selection module 1926. The analysis module 1924 analyses a set of answers to polling question corresponding to one of a user and a computer system relative to answers provided by different groups of users. Advertisement selection module 1926 selects an advertisement to be presented to a user or a computer system as a function of the analysis of module 1924.

The advertisement selection module 1926, for at least some cases, uses stored information indicating advertisements known to have been of interest to members of a group of users having a similar voting history to a user or a computer system for which an advertisement selection is being determined.

In various embodiments, one of said analysis module 1924 and advertisement selection module 1926 includes a collaborative filter. In some embodiments, the selection module 1922 selects, for at least some selections, an advertisement as a function of non-vote related information stored corresponding to a user and/or computer system, e.g., as a function of stored user profile information such as male/female, age, interests, occupation, hobbies, etc. in addition to answers to previous polls. In some embodiments, the selection module 1922 selects an advertisement and/or link as a function of information corresponding to a web site being visited in addition to answers to previous polls.

Tracking module 1928 tracks the display of advertisements, e.g., the display of targeted advertisements which have been selected by selection module 1922. Billing module 1930 bills advertisement sponsors based on the display of advertisements. In some embodiments, where an advertisement provides a clickable link, the tracking module 1928 also tracks user selection to go to the link. In some such embodiments, billing can be, and sometimes is also based on user selection of the presented link.

Received information processing module 1932 processes the information received through receiver module 1916, e.g., storing received advertisement information from a sponsor in memory 1910, storing a received poll answer from a user or computer system in memory such that it is associated with the particular user or computer system. Received information processing module 1932 also updates poll results, e.g., updating a poll summary result to a particular question.

Poll results signaling module 1934 generates a poll results signal to be communicated via transmission module 1914 to a user computer system, e.g., in response to a received user answer to a poll question and/or as part of an automatic update. Advertisement signaling selection module 1936 generates a advertisement information signal to a user's computer system to convey a selected advertisement or link and/or to identify a selected advertisement and/or link for presentation to a particular user or to a particular computer system.

The techniques of the present invention may be implemented using software, hardware and/or a combination of software and hardware. The present invention is directed to apparatus, e.g., computers and/or various communications systems which implement the present invention. It is also directed to methods, e.g., methods of controlling and/or operating devices such as computer systems in accordance with the present invention. The present invention is also directed to machine readable medium, e.g., ROM, RAM, CDs, hard discs, etc., which include machine readable instructions for controlling a machine to implement one or more steps in accordance with the present invention.

Variations on the above described exemplary embodiments will be apparent to those skilled in the art in view of the above description of the invention. Such embodiments are considered to be part of the present invention.

What is claimed is:

1. A method of targeting advertisements, the method comprising:
storing information relating to answers to polling questions, said answers corresponding to one of a user and a computer system; and
using the stored information relating to answers to polling questions to select at least one of: i) an advertisement and ii) a link to an advertisement to be provided to the corresponding one of said user and said computer system.

2. The method of claim 1, wherein using the stored information relating to answers to polling questions includes:
analyzing a set of answers to polling questions corresponding to the user or computer system relative to answers provided by different groups of users; and
selecting an advertisement to be presented to the user or computer system as a function of said analysis.

3. The method of claim 2, wherein selecting an advertisement includes selecting an advertisement known to have been of interest to members of a group of users having a similar voting history to said user or computer system.

4. The method of claim 3, wherein at least some of said groups of users are groups defined by user characteristics at least some of which are non-voting history characteristics.

5. The method of claim 3, wherein collaborative filtering is used in at least one of said analyzing and selecting steps.

6. The method of claim 1, wherein the advertisements are selected as a function of information corresponding to a web site being visited in addition to answers to previous polls.

7. The method of claim 6, wherein the method also includes:
using information on a collection of polling results being displayed to select an advertisement or link to an advertisement.

8. The method of claim 7, further comprising:
tracking the display of advertisements; and
billing advertisement sponsors based on the display of advertisements.

9. The method of claim 6, further comprising:
selling polling result information.

10. The method of claim 9, wherein said polling result information is sold to advertisers for use by said advertisers in selecting advertisements to be displayed.

11. A system for targeting advertisements, the system comprising:
memory for storing information relating to answers to polling questions, said answers corresponding to one of a user and a computer system; and
a selection module for selecting at least one of: i) an advertisement and ii) a link to an advertisement to be provided to the corresponding one of said user and said computer system based on the stored information relating to answers to polling questions.

12. The system of claim 11, wherein said selection module includes:
an analysis module for analyzing a set of answers to polling questions corresponding to said one of the user and computer system relative to answers provided by different groups of users; and
an advertisement selection module for selecting an advertisement to be presented to the user or computer system as a function of said analysis.

13. The system of claim 12, further comprising:
stored voting history information for a plurality of users;
information indicating advertisements known to have been of interest to members of a group of users having a similar voting history to the one of said user and said computer system; and
wherein said advertisement selection module uses said stored information indicating advertisements known to have been of interest to members of the group of users having a similar voting history to the one of said user and said computer system to select an advertisement.

14. The system of claim 13, wherein said stored voting history information includes information for at least some groups of users defined by user characteristics at least some of which are non-voting history characteristics, said stored voting history information including at least some non-voting history characteristic information corresponding to users for which voting history information is stored.

15. The system of claim 13, wherein one of said analysis module and selection module includes a collaborative filter.

16. The system of claim 11, wherein said selection module selects an advertisement as a function of information corresponding to a web site being visited in addition to answers to previous polls.

17. The system of claim 16, further comprising:
a tracking module for tracking the display of advertisements; and
a billing module for billing advertisement sponsors based on the display of advertisements.
